(19) United States
(12) Patent Application Publication
(10) Pub. No.: US 2009/0004391 A1
(43) Pub. Date: Jan. 1, 2009

(54) Method of reducing formaldehyde emissions from an insulation product

(76) Inventors: Fatemeh N. Olang, Granville, OH (US); Harry B. Cline, Heath, OH (US)

Correspondence Address: OWENS CORNING, 2790 COLUMBUS ROAD, GRANVILLE, OH, 43023, US

(21) Appl. No.: 11/823,955

(22) Filed: Jun. 29, 2007

(51) Int. Cl. B05D 3/02

(52) U.S. Cl. 427/385.5

(57) ABSTRACT

A method of reducing formaldehyde emissions from a fibrous insulation product is provided. Fibers are formed, and a binder including a curable formaldehyde-containing resin is applied to the fibers to form a pack. The pack is introduced into a curing oven to cure the resin. During the curing, moisture is applied to the pack. For example, the moisture can be applied by injecting steam into the curing oven. The pack with the cured resin is removed from the oven. The pack is formed into the fibrous insulation product. The fibrous insulation product has reduced formaldehyde emissions compared to the same product without the moisture application.

### TECHNICAL FIELD AND INDUSTRIAL APPLICABILITY OF THE INVENTION

This invention relates in general to the field of fibrous insulation products, and in particular to insulation products including a formaldehyde-containing resin as a binder. The invention is applicable to the manufacture of these insulation products.

### BACKGROUND OF THE INVENTION

Some fibrous insulation products include a formaldehyde-containing resin as a binder. After the manufacture of the insulation products, a portion of the formaldehyde may be released from the resin and emitted into the atmosphere. It would be desirable to reduce formaldehyde emissions from insulation products.

A number of patents address reduced formaldehyde emissions from textiles. For example, U.S. Pat. No. 3,768,969 discloses sensitized textiles with decreased formaldehyde odor. The textiles are produced by a method which includes subjecting fabric impregnated with a cross linking agent and a catalyst to superheated steam for selected periods of time so that the steam removes moisture and free formaldehyde simultaneously.

U.S. Pat. No. 3,617,198 teaches to reduce formaldehyde emissions from sensitized fabrics by subjecting them to moist air or steam which releases and carries free formaldehyde away.

Another patent, U.S. Pat. No. 6,296,795, does not address formaldehyde emissions, but discloses a process for producing a non-woven fibrous insulation batt wherein a partially cured batt is contacted with steam as part of the process. The batt is made with a binder that swells and becomes sticky upon contact with the steam.

It would be desirable to provide a method of reducing formaldehyde emissions from fibrous insulation products.

### SUMMARY OF THE INVENTION

A method of reducing formaldehyde emissions from a fibrous insulation product is provided. Fibers are formed, and a binder including a curable formaldehyde-containing resin is applied to the fibers to form a pack. The pack is introduced into a curing oven to cure the resin. During the curing, moisture is applied to the pack. For example, the moisture can be applied by injecting steam into the curing oven. The pack with the cured resin is removed from the oven. The pack is formed into the fibrous insulation product. The fibrous insulation product has reduced formaldehyde emissions compared to the same product without the moisture application.

In another embodiment, a fibrous insulation product is provided comprising a formed pack including fibers which are held together by a cured formaldehyde-containing resin. Steam is blown through the fibrous insulation product. The fibrous insulation product after the steam blowing has reduced formaldehyde emissions compared to the product before the steam blowing.

In another embodiment, a fibrous insulation product comprises a formed pack including fibers which are held together by a cured formaldehyde-containing resin. The resin has been cured by introducing the pack into a curing oven, and during the curing applying moisture to the pack. The fibrous insulation product has reduced formaldehyde emissions compared to the same product without the moisture application.

Various aspects of the method and product become apparent to those skilled in the art from the following detailed description of the preferred embodiments, when read in light of the accompanying drawing.

### BRIEF DESCRIPTION OF THE DRAWING

FIG. 1 is a perspective view of an oven assembly that can be used in the method for curing a resin binder during the manufacture of a fibrous insulation product.

### DETAILED DESCRIPTION AND PREFERRED EMBODIMENTS OF THE INVENTION

A method of reducing formaldehyde emissions from a fibrous insulation product is provided. The following description first describes the typical aspects of a conventional method of producing fibrous insulation products, and then describes the aspects of the present method.

Fibrous insulation is typically manufactured by forming fibers from a molten fiberizable material. Any suitable fiberizable material can be used. For example, the fibers can be formed from a mineral such as glass, basalt, rock or slag, a polymer such as polypropylene or polyester, or combinations of different materials. In one embodiment, the fibers are glass fibers, for example, glass fibers having a diameter of between 1 and 25 microns.

The fibers can be formed by any suitable process. One such process is a rotary process, in which molten glass is placed into a fiberizer that is a rotating spinner having orifices in the perimeter, wherein glass flows out the orifices to produce a downwardly falling veil or stream of fibers. Another process is a continuous process in which molten glass is placed into a fiberizer known as a feeder or bushing that has an orificed bottom wall, and glass fibers are pulled downward from the bottom wall.

A binder applicator applies an uncured binder on the veil of fibers produced by the fiberizer. The binder is typically a solution containing water, an organic resin, and one or more adjuvants such as a curing agent, coupling agent, oil, surfactant, dye, filler, thermal stabilizer, flame retarding agent and/or lubricant. The binder can have any suitable composition, but typically includes from about 70 wt % to about 98 wt % water, from about 2 wt % to about 30 wt % resin, and not more than about 30 wt % adjuvant(s).

Organic resins exist in the uncured state as liquids in solution. The resin can be cured to crosslink the resin and provide strong bonds with the fibers. The terms “curing the binder” and “curing the resin” will be used interchangeably herein, and “curing” will include not only crosslinking but any curing process that solidifies the binder. The binder is not necessarily a solution, but can be in any form suitable for application to the fibers, such as a powder.

The binder applicator can be any type of apparatus suitable for applying the binder to the fibers, such as a sprayer or other well-known applicator. For example the binder can be applied by spraying through liquid pressure spray tips or air atomized spray tips. Any suitable amount of binder can be applied to the fibers, for example, an amount within a range of from about 0.1% to about 20% by weight of the insulation product.

The veil of fibers having the binder applied thereto is collected as a pack on a conveyor or other suitable collection apparatus. The pack is the collection or mass of intermingled fibers having the uncured binder dispersed throughout the fibers. After the binder is cured, as described below, the binder bonds the fibers together where they contact each other within the pack to form a three dimensional network. The binder holding the individual fibers of the collection of fibers together provides the collection with the integrity to maintain a formed product.

The pack is introduced into a curing oven to cure the binder. Any suitable type of curing oven can be used. Typically, the pack is cured within the oven by hot curing gases, such as hot air. The hot curing gases can be supplied to the oven from a source of hot gas via a supply duct. The curing gases can be removed from the oven via an exhaust duct. Any suitable curing oven temperatures can be used, for example, curing temperatures within a range of from about 300° F. (149° C.) to about 1000° F. (538° C.) depending upon curing time. Any suitable curing time can be used, for example, a time between about 2 seconds and about 15 minutes. The pack can be conveyed through the curing oven by any means suitable for carrying the pack through the oven while enabling the flow of curing gases through the pack. For example, the pack can be conveyed between upper and lower foraminous belts that travel through the oven.

The pack with the cured binder is removed from the curing oven and cooled. The pack is formed into any suitable type of fibrous insulation product, including a light density insulation product such as an insulation mat, blanket or batt, or a heavy density insulation product such as a compressed insulation board or panel. The light density products typically have a density between about 0.3 and about 1.0 pounds per cubic foot (pcf) (between about 4.8 to about 16 kg/m³), while the heavy density products typically have a density between about 2.0 and about 15.0 pounds per cubic foot (pcf) (between about 32 and about 240 kg/m³). The manufacturing process for a compressed insulation product usually includes holding the pack under compression during the curing process. The insulation products are typically formed and cut to provide sizes generally compatible with standard construction practices.

The method provided herein reduces formaldehyde emissions from a fibrous insulation product. The insulation product is made with a binder that includes a curable formaldehyde-containing resin. The curable resin can be any type that includes formaldehyde and that is suitable for use in a binder, such as a phenol/formaldehyde resin, a urea/formaldehyde resin, a melamine/formaldehyde resin, a triazone resin, or a mixture thereof.

Phenol/formaldehyde (PF) resins suitable for use in binders are well-known and widely commercially available. These resins may be prepared from phenol and formaldehyde monomers in manners well-known to those skilled in the art. In addition to phenol itself, other hydroxy-functional aromatic compounds can be employed, or used in addition to phenol. Any of the wide variety of procedures used for reacting the principal phenol and formaldehyde components to form an aqueous PF resin can be used, such as a base-catalyzed condensation reaction. Generally, the formaldehyde and phenol are reacted at a mole ratio of formaldehyde to phenol in the range of about 2:1 to 4.5:1. Examples of commercially available phenol/formaldehyde resins include Durite IB-165B from Hexion Specialty Chemicals, Columbus, Ohio, Chem-Bond 360s from Dynea Resins, Toledo, Ohio, and GP 2895 from Georgia-Pacific Resins, Inc., Atlanta, Ga.

Urea/formaldehyde (UF) resins suitable for use in binders are well-known and widely commercially available. These resins may be prepared from urea and formaldehyde monomers or from UF precondensates in manners well-known to those skilled in the art. Any of the wide variety of procedures used for reacting the principal urea and formaldehyde components to form an aqueous UF resin can be used, such as staged monomer addition, staged catalyst addition, pH control, or amine modification. Generally, the urea and formaldehyde are reacted at a mole ratio of formaldehyde to urea in the range of about 1.1:1 to 4:1. Examples of commercially available urea/formaldehyde resins include the Casco® resins sold by Hexion Specialty Chemicals, Columbus, Ohio, and the GP-series of resins sold by Georgia Pacific Resins, Inc., Atlanta, Ga.

In one embodiment, the binder comprises a premix of a urea modified phenol-formaldehyde resole resin. Urea is typically added to phenouformaldehyde resin to produce a urea modified phenol/formaldehyde resole resin (also referred to as “premix” or “pre-react”). The premix can also contain any suitable additive(s), such as an oil emulsion, a curing agent and/or a coupling agent.

Any suitable premix of a urea modified phenol-formaldehyde resole resin can be used. The premix may be prepared in advance of the preparation of the binder, or may be supplied by a resin manufacturer, and stored until it is required for use to prepare the binder. The premix of a urea modified phenol-formaldehyde resole resin for use in the method can be prepared in any suitable manner. Examples of suitable premixes and methods for their manufacture are disclosed in U.S. Pat. No. 5,300,562 which is herein incorporated by reference.

The formaldehyde emissions from the cured fibrous insulation product are reduced by any suitable amount. In some embodiments, the formaldehyde emissions are reduced by at least about 10%, at least about 20%, or at least about 30%, depending on the particular method and product. The reduction in formaldehyde emissions from the product is in comparison with the same product made by the same manufacturing process except that it does not include the present method.

The formaldehyde emissions are measured by any suitable method, for example, by any suitable technique for air sample collection of the headspace over the product and chemical analysis to identify the amount of formaldehyde being emitted. In one embodiment, a sample product is loaded into a controlled environmental chamber designed to measure emissions from the sample. Any suitable sized environmental chamber can be used, for example, when the test samples are hand sheets (described below) the test chamber may be a jar which is 1 quart (0.95 liter) in size. Test chambers are manufactured by Air Quality Sciences, Inc. (AQS), Atlanta, Ga. The interior of the environmental chamber may be designed to provide an inert environment so that background emissions levels are kept as low as possible, for example, meeting the specifications of ASTM D5116-97 and ASTM D 6670-01. In another embodiment, the formaldehyde emissions are measured by the AATCC Test Method 112-1978 (Sealed Jar Method), which measures formaldehyde release as a vapor from a sample stored over water in a sealed jar at 30° C. for 24 hours. In another embodiment, the formaldehyde emissions are measured by a modified jar method. The modified jar method differs from the standard jar method in the way the sample is loaded into the jar. In the modified method small disks of hand sheets (like potato chips) are loaded onto a glass rod in a manner similar to making a shish kabob, whereas in the standard jar method small pieces of hand sheets are loaded onto a Teflon® mesh stand. Also, the modified method measures the formaldehyde release in a sealed jar at 21° C. for 24 hours instead of 30° C.

The present method causes decreased formaldehyde emissions from the cured product by applying moisture to the pack of fibers and resin during the curing process. The moisture can be applied by any suitable method. In one embodiment, the method causes the moisture to penetrate into the pack to reach at least a major portion of the resin.

The reduction in formaldehyde emissions can be caused by any mechanism. In one embodiment, it is believed that the moisture application may affect the formation of methylene and ether linkages in the cured binder and thereby reduce the product formaldehyde emission, although other mechanism(s) may be involved.

In one embodiment, the moisture is applied by injecting steam into the curing oven. Any suitable amount of steam can be injected into the oven. The amount of steam will generally relate to the amount of binder and/or the amount of fiber that is processed through the curing oven. In one embodiment, the curing process is a continuous process, and steam is injected into the curing oven at a rate of at least about 3 pounds (1.362 kg) of water injected per pound (0.454 kg) of binder that travels through the curing oven, specifically at least about 4.5 pounds (2.043 kg) of water per pound (0.454 kg) of binder, and more specifically at least about 6 pounds (2.724 kg) of water per pound (0.454 kg) of binder depending on the particular process and product. Also in one embodiment, the steam is injected into the curing oven at a rate of at least about 0.15 pound (0.068 kg) of water injected per pound (0.454 kg) of fiber that travels through the curing oven, specifically at least about 0.2 pound 0.091 kg) of water per pound (0.454 kg) of fiber, and more specifically at least about 0.25 pound (0.114 kg) of water per pound (0.454 kg) of fiber.

The steam can be injected in any suitable manner. In one embodiment, the steam is injected continuously during a continuous curing process, although it could alternatively be injected discontinuously and/or the curing process could be a batch process.

Any suitable steam pressure can be used. In one embodiment, the steam is introduced into the curing oven under a pressure within a range of from about 50 psig (3.515 kg/cm²) to about 200 psig (14.06 kg/cm²), and more specifically from about 100 psig (7.03 kg/cm²) to about 150 psig (10.545 kg/cm²).

The air inside the curing oven including the suspended steam can flow through the pack at any suitable velocity. In one embodiment, the air flow through the pack is limited to prevent surface deformation of the pack.

The steam can have any suitable temperature when it is injected. In one embodiment, the steam is injected at a temperature of at least about 280° F. (138° C.), specifically within a range of from about 325° F. (163° C.) to about 600° F. (316° C.), and more specifically from about 325° F. (163° C.) to about 400° F. (204° C.).

The pack can be any suitable temperature when the steam is injected. In one embodiment, the steam is injected when the pack is at a temperature of at least about 200° F. (93° C.), specifically at least about 250° F. (121° C.), and more specifically within a range of from about 300° F. (149° C.) to about 500° F. (260° C.).

Besides injecting steam into the oven, moisture can be applied to the pack by any other suitable method. For example, water can be applied directly to the pack by spraying or any other suitable means.

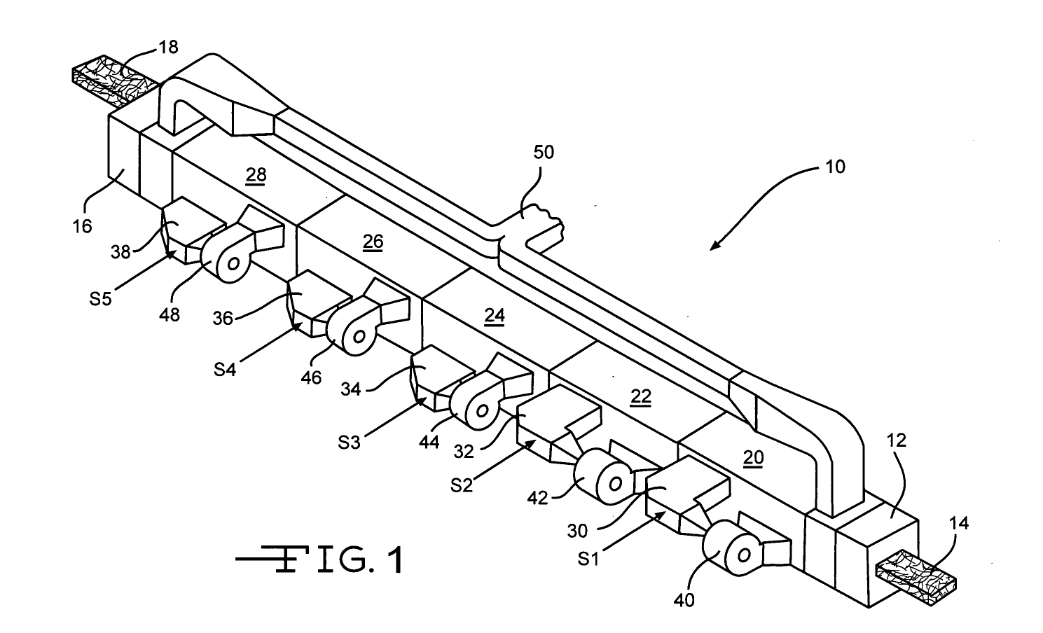

FIG. 1 shows an example of one type of oven assembly 10 that can be used for curing a resin binder during the manufacture of a fibrous insulation product. It is to be understood that many other types of curing ovens can also be used. The oven assembly 10 includes a charge end 12 where an uncured pack 14 containing fibers and an uncured binder is charged into the oven assembly, and a discharge end 16 where the cured pack 18 is discharged from the oven assembly. The oven assembly 10 is divided into five zones, including exterior zones 20 and 28, and interior zones 22, 24 and 26. It is to be understood that other types of curing ovens can have different numbers of zones, such as four zones, or can be unseparated into zones. In some embodiments of five zone or four zone curing ovens, the primary function of the first zone 20 is to dry the binder while the primary function of the remaining zones is to cure the binder.

The oven assembly includes burners 30, 32, 34, 36 and 38 which are connected by ductwork to recirculating fans 40, 42, 44, 46 and 48, respectively. The burners and recirculating fans are also connected by ductwork to the oven zones. The recirculating fans pull air from the oven zones. The air flows from the oven zones to the burners where it is heated, and then the recirculating fans put the air flow back into the oven zones. The oven assembly also includes an exhaust system 50 to vent the exhaust air from the oven zones to an incinerator.

The oven assembly 10 includes means to introduce steam into the oven during the curing process. The steam can be introduced in any manner suitable for creating a high humidity environment effective to result in reduced product formaldehyde emission. For example, the oven assembly shown could have steam injected into one or more of the different zones at the steam injection locations designated as S1, S2, S3, S4 and S5. In one embodiment of the method, the steam is injected into one or more of the interior zones 22, 24 or 26 rather than the exterior zones 20 or 28, to prevent steam from escaping through the charge end 12 or the discharge end 16 of the oven assembly. The steam can be injected into any suitable number of zones; in one embodiment, the steam is injected into just one of the interior zones, for example into zone 24 from steam injection location S3.

The steam S3 can be injected into the zone 24 or other zone in any suitable manner. In one embodiment, the steam S3 is injected through a steam pipe (not shown) that feeds the steam into the ductwork of the burner 34 at any suitable location. For example, the steam can be injected into the ductwork after burner 34 and before the fan 44. The steam can also be injected into the suction side of the fan 44 or on the exhaust side of the fan 44. However, it is to be understood that many other methods and locations of steam injection can be used.

In one embodiment, the steam is not injected into the curing oven until after substantially all the water of the binder has been evaporated. For example, the evaporation of substantially all the water in the binder may occur in the first zone 20 of the curing oven 10. The steam then is injected into one of the subsequent zones 22 etc.

The fibrous insulation product comprises a formed pack including fibers which are held together by a cured formaldehyde-containing resin. The resin has been cured by introducing the pack into a curing oven, and during the curing applying moisture to the pack. The fibrous insulation product has reduced formaldehyde emissions compared to the same product without the moisture application.

In addition to the reduced formaldehyde emissions, the method may improve the surface characteristics of the fibrous insulation product. For example, the method may improve the surface look/quality of the product, and specifically the product may have a smoother surface rather than a surface having visual defects or non-uniformities in it. Also, the method may improve the recovery of the fibrous insulation product, its ability to return to its original form after it is compressed. However, these improvements are not required.

In another embodiment, a method of reducing formaldehyde emissions from a fibrous insulation product includes blowing steam through the product instead of injecting steam into the curing oven. This method comprises providing a fibrous insulation product which is a formed pack including fibers which are held together by a cured formaldehyde-containing resin, and blowing steam through the fibrous insulation product. The fibrous insulation product after the steam blowing has reduced formaldehyde emissions compared to the product before the steam blowing. The steam blowing of the product can be conducted at any suitable time, for example, during the cooling stage of the product manufacturing process, or after the product has been removed from the manufacturing line. Any suitable steam blowing apparatus can be used for the method.

### First Series of Experiments

The goal of these experiments was to study the effect of a humid environment during resin curing on the level of formaldehyde emitted from the final insulation products. These experiments consisted of the study of hand sheets and the study of pipe basic insulation.

Hand sheets—A binder was prepared containing 870 g water, 78.40 g phenol/formaldehyde resin, 39.90 g urea (50%), 10.65 g oil emulsion, 6.21 g ammonium sulfate (curing agent) and 0.1199 g silane (coupling agent). The binder had a pH of about 9. Hand sheets were prepared from ¼ inch (0.635 cm) wet use chopped glass strands, having a diameter of about 7-8 microns, held together by the binder (in the amount of 4-7 wt %) and formed into approximately 12 inch (30.48 cm) by 12 inch (30.48 cm) sheets by 1/16 inch (0.159 cm). The hand sheets were cured in a Mathis oven at 400° F. (204° C.) for a total of 3 minutes unless is stated differently. A low pressure steam line (lab steam) was connected into the oven when hand sheets were subjected to the steam curing condition. Also a known amount of water was sprayed by a regular spray bottle on the hand sheets when hand sheets were subjected to water spray curing conditions. Hand sheets with different curing profile, according to Table 1, were compared for formaldehyde emissions. Measurements were done by a modified jar test at room temperature (21° C.) in ten replications.

TABLE 1
Hand Sheets Curing Conditions for Steam Experiment

| Hand sheets | Curing Condition |
|---|---|
| Controls | 400° F. (204° C.), 3 minutes |
| Steam cured | 400° F. (204° C.), 3 minutes |
| | 100 ± 5 g steam/minute |
| Water sprayed | 400° F. (204° C.), 1.5 minutes |
| | 15 ± 2 g water |
| | 400° F. (204° C.), 1.5 minutes |

Pipe Basic—Uncured Pipe Basic insulation samples were obtained, which were of the type of glass fiber insulation typically molded and cured into fiberglass pipe insulation products. Typically, the glass fibers have a diameter of about 7-8 microns, and when formed into a pipe insulation product the product density is about 3-6 pcf (48-96 kg/m³) and the binder content is about 4-7 wt %. The samples were obtained in five different hours of a day. Each sample was cut into six parts and the parts were randomized. Using the Mathis oven in a lab, three out of six parts were cured for 11 minutes at 400° F. (204° C.). The remaining three parts were cured in the same oven for 11 minutes at 400° F. (204° C.) with a low pressure steam line (lab steam) connected into the oven entering 155±5 g/min of steam into the oven.

Product formaldehyde emissions were measured by desiccator test using the Jar test jars as the desiccators. Three replicates for each part resulted in nine replicates per sample per cure condition. This resulted in total of 45 formaldehyde tests for steam cured samples and 45 formaldehyde tests for no-steam cured samples.

Results:

Hand Sheets: A significant decrease in formaldehyde emissions level was observed for both hand sheets cured under the steam and those sprayed with water during the curing process. It was shown that the formaldehyde emissions were reduced by about 35% for the hand sheets sprayed with water during the curing process, compared to the control hand sheets. Steam also reduced the formaldehyde emissions by about 20% compared to the control samples. The jar test (at room temperature) showed a statistically significant difference in the level of formaldehyde emitted from the hand sheets cured with different curing profiles. Data analysis is presented below:

TABLE 2
Analysis of Formaldehyde Emissions from Cured Hand Sheets
Two-Sample T-Test and CI: Control Hand Sheet, Water Sprayed
Hand Sheet

| | N | Mean | StDev | SE Mean |
|---|---|---|---|---|
| Control Hand Sheets | 10 | 45.73 | 3.88 | 1.2 |
| Water Sprayed Hand Sheets | 10 | 28.78 | 3.65 | 1.2 |

Difference = mu (Control Hand Sheet) − mu (Water Sprayed Hand Sheet)
Estimate for difference: 16.9514
95% CI for difference: (13.3963, 20.5065)
T-Test of difference = 0 (vs not =): T-Value = 10.06 P-Value = 0.000
DF = 17

Two-Sample T-Test and CI: Control Hand Sheet, Steam Cured Hand
Sheets

| | N | Mean | StDev | SE Mean |
|---|---|---|---|---|
| Control Hand Sheets | 10 | 45.73 | 3.88 | 1.2 |
| Steam Cured Hand Sheets | 10 | 38.04 | 2.48 | 0.79 |

Difference = mu (Control Hand Sheet) − mu (Steam Cured Hand Sheets)
Estimate for difference: 7.69482
95% CI for difference: (4.58699, 10.80265)
T-Test of difference = 0 (vs not =): T-Value = 5.28 P-Value = 0.000
DF = 15

Pipe Basic—Desiccator test showed curing of pipe basic in the presence of steam significantly decreases the amount of product formaldehyde emissions. It was shown in laboratory studies that steam reduces the average formaldehyde emitted from the pipe basic insulation by 74%.

The modified jar tests (at room temperature) showed a statistically significant difference in the level of formaldehyde emitted from the pipe basic cured with and without the steam, as shown in Table 3 below:

TABLE 3
Analysis of Formaldehyde Emissions from Cured Pipe Basic Insulation
Two-Sample T-Test and CI: FORMALDEHYDE, CURED CONDITION

| CURED CONDITION | N | Mean | StDev | SE Mean |
|---|---|---|---|---|
| NO-STEAM | 45 | 3.423 | 0.734 | 0.11 |
| STEAM | 43 | 0.903 | 0.369 | 0.056 |

Difference = mu (NO-STEAM) − mu (STEAM)
Estimate for difference: 2.51968
95% CI for difference: (2.27379, 2.76557)
T-Test of difference = 0 (vs not =): T-Value = 20.47 P-Value = 0.000 DF = 65

We have also measured the formaldehyde emissions of the pipe samples by AATCC method at elevated temperature. AATCC also showed that steam reduces the product formaldehyde emissions by 57%, from a mean of 243.604 to a mean of 104.899.

Conclusion:

Hand sheets and pipe basic cured with a steam line connected to the oven showed a significant reduction in product formaldehyde emissions compared to when they were cured without steam. Formaldehyde emissions reduction, measured at room temperature by Jar test, for pipe basic was about 74%. To confirm this data we have also tested the samples with the AATCC method at elevated temperature (49° F., 9.4° C.). AATCC also showed 57% reduction in the formaldehyde emissions when the pipe basic insulation was cured with steam.

### Second Series of Experiments

Experiments were conducted using a 4-zone oven, where steam was injected into oven zone 2 and then oven zone 3 at a low and a high flow level. Both insulation batt samples and blowing wool insulation samples for each setpoint were sent to AQS for formaldehyde testing. It was determined that formaldehyde emissions were reduced from the products.

Experiments were conducted where steam was injected into the oven during the curing of insulation batt samples and blowing wool insulation samples. AQS test results showed a 20-35% reduction in product formaldehyde emissions depending on the amount of steam injected into the oven. Other product properties were not impacted by the addition of steam to the oven.

Experiments were conducted where steam was injected into oven zone 2 and then oven zone 3 at a low flow level, 2800 lb/hr (1271.2 kg/hr), and a high flow level, 4200 lb/hr (1906.8 kg/hr). The end of line product properties for the steam injection setpoints were equivalent to the standard product. Insulation batt samples for each setpoint were sent to AQS for formaldehyde testing, and to a lab for product property testing. Blowing wool samples were sent to AQS for testing. The AQS test results for insulation batt samples and blowing wool samples are shown below in Tables 4 and 5.

TABLE 4
AQS Formaldehyde Results For
Steam Injection During Curing of Insulation Batts

| | | AQS | AQS |
|---|---|---|---|
| Steam | Steam Flow | Modeled Conc. At | Modeled Conc. At |
| Injection | lb/hr (kg/hr) | 96 hours, ppm | 96 hours, ppm |
| Control | 0 | 0.028 | 0.029 |
| Zone 2 | 2800 (1271.2) | 0.019 | 0.023 |
| Zone 3 | 2800 (1271.2) | 0.018 | 0.024 |
| Zone 2 | 4200 (1906.8) | 0.024 | 0.022 |
| Zone 3 | 4200 (1906.8) | 0.019 | 0.019 |

TABLE 5
AQS Formaldehyde Results For Steam
Injection During Curing of Blowing Wool Insulation

| | | | Sep. 12, 2006 |
|---|---|---|---|
| | | Jul. 18, 2006 | AQS Modeled |
| Steam | Steam Flow | AQS Modeled Conc. At | Conc. At |
| Injection | lb/hr (kg/hr) | 96 hours, ppm | 96 hours, ppm |
| Control | 0 | 0.47 | 0.071 |
| Zone 2 | 2800 (1271.2) | 0.56 | 0.064 |
| Zone 3 | 2800 (1271.2) | 0.40 | 0.053 |
| Zone 2 | 4200 (1906.8) | 0.18 | 0.048 |
| Zone 3 | 4200 (1906.8) | 0.25 | 0.080 |

In accordance with the provisions of the patent statutes, the principle and mode of operation of method and product have been explained and illustrated in its preferred embodiments. However, it must be understood that the method and product may be practiced otherwise than as specifically explained and illustrated without departing from its spirit or scope.

What is claimed is:

1. A method of reducing formaldehyde emissions from a fibrous insulation product comprising:
forming fibers and applying a binder including a curable formaldehyde-containing resin to the fibers to form a pack;
introducing the pack into a curing oven to cure the resin, and during the curing applying moisture to the pack;
removing the pack with the cured resin from the oven, and forming the pack into the fibrous insulation product;
the fibrous insulation product having reduced formaldehyde emissions compared to the same product without the moisture application.

2. The method of claim 1 wherein the moisture is applied by injecting steam into the curing oven.

3. The method of claim 2 wherein the steam is injected into the curing oven at a rate of at least about 3 pounds (1.362 kg) of water injected per pound (0.454 kg) of binder that travels through the curing oven.

4. The method of claim 3 wherein the steam is injected into the curing oven at a rate of at least about 4.5 pounds (2.043 kg) of water injected per pound (0.454 kg) of binder that travels through the curing oven.

5. The method of claim 2 wherein the steam is injected into the curing oven at a rate of at least about 0.15 pound (0.068 kg) of water injected per pound (0.454 kg) of fiber that travels through the curing oven.

6. The method of claim 5 wherein the steam is injected into the curing oven at a rate of at least about 0.2 pound (0.091 kg) of water injected per pound (0.454 kg) of fiber that travels through the curing oven.

7. The method of claim 2 wherein the curing oven includes an interior zone and an exterior zone, and wherein the steam is injected into the interior zone.

8. The method of claim 2 wherein the steam is introduced into the curing oven under a pressure within a range of from about 50 psig (3.515 kg/cm²) to about 200 psig (14.06 kg/cm²).

9. The method of claim 2 wherein the steam is injected when the pack is at a temperature of at least about 200° F. (93° C.).

10. The method of claim 2 wherein the steam is not injected into the curing oven until after substantially all the water of the binder has been evaporated.

11. The method of claim 1 wherein the formaldehyde emissions from the fibrous insulation product are reduced by at least about 10%.

12. The method of claim 11 wherein the formaldehyde emissions are reduced by at least about 20%.

13. The method of claim 1 wherein the resin is selected from the group consisting of urea/formaldehyde resin, phenol/formaldehyde resin, and mixtures thereof.

14. The method of claim 1 wherein the fibers are formed from glass.

15. The method of claim 1 wherein the moisture application affects the formation of methylene and ether linkages in the cured binder and thereby reduces the product formaldehyde emission.

16. A method of reducing formaldehyde emissions from a fibrous insulation product comprising:
providing a fibrous insulation product comprising a formed pack including fibers which are held together by a cured formaldehyde-containing resin; and
blowing steam through the fibrous insulation product;
the fibrous insulation product after the steam blowing having reduced formaldehyde emissions compared to the product before the steam blowing.

17. The method of claim 16 wherein the steam is blown in an amount of at least about 3 pounds of water per pound of binder.

18. The method of claim 16 wherein the formaldehyde emissions from the fibrous insulation product are reduced by at least about 10%.

19. A fibrous insulation product comprising:
a formed pack including fibers which are held together by a cured formaldehyde-containing resin;
the resin having been cured by introducing the pack into a curing oven, and during the curing applying moisture to the pack;
the fibrous insulation product having reduced formaldehyde emissions compared to the same product without the moisture application.

20. The fibrous insulation product of claim 19 wherein the formaldehyde emissions are reduced by at least about 10%.
